(19) United States
(12) Patent Application Publication
(10) Pub. No.: US 2026/0148297 A1
(43) Pub. Date: May 28, 2026

(54) RECURRING ON-CHAIN TRANSFERS

(71) Applicant: Coinbase, Inc., Oakland, CA (US)

(72) Inventor: Aniket Bhatnagar, Dublin (IE)

(21) Appl. No.: 18/963,266

(22) Filed: Nov. 27, 2024

(51) Int. Cl. G06Q 40/04; G06Q 20/06; H04L 9/00; H04L 9/32

(52) U.S. Cl. CPC G06Q 40/04; G06Q 20/0655; H04L 9/3247; H04L 9/50; G06Q 2220/00; H04L 2209/56

(57) ABSTRACT

Methods, systems, and devices for data management are described. A client application may receive user inputs to initiate authorization of multiple instances of a transfer of a first amount of a first crypto token from a first blockchain address associated with a blockchain application to a second blockchain address. The client application may transmit, to a blockchain address application after receiving the user inputs, a payload for signature at the blockchain address application and for registration, via a smart contract, of the authorization of the multiple instances of the transfer. The client application may broadcast one or more messages to call the smart contract, where the one or more messages are configured to trigger an instance of the multiple instances of the transfer of the first amount of the first crypto token from the first blockchain address to the second blockchain address on a blockchain network by referencing the registration.

### FIELD OF TECHNOLOGY

The present disclosure relates generally to data management, including techniques for recurring on-chain transfers.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports recurring on-chain transfers in accordance with aspects of the present disclosure.

FIGS. 2 and 3 show examples of user interface flows that support recurring on-chain transfers in accordance with aspects of the present disclosure.

FIGS. 4 through 7B show example of process flows that support recurring on-chain transfers in accordance with aspects of the present disclosure.

FIG. 8 shows a block diagram of an apparatus that supports recurring on-chain transfers in accordance with aspects of the present disclosure.

FIG. 9 shows a block diagram of a recurring on-chain transfer manager that supports recurring on-chain transfers in accordance with aspects of the present disclosure.

FIG. 10 shows a diagram of a system including a device that supports recurring on-chain transfers in accordance with aspects of the present disclosure.

FIGS. 11 and 12 show flowcharts illustrating methods that support recurring on-chain transfers in accordance with aspects of the present disclosure.

### DETAILED DESCRIPTION

Some blockchain networks or applications that facilitate operations via blockchain networks may not support recurring on-chain transfers. That is, in some cases, blockchain applications may support or enable a user to sign a transaction and broadcast, via a blockchain network, the signed transaction for a single transfer at a time. However, support or enablement of recurring on-chain transfers may support a reduction in resource overhead and improvement in user experience. Accordingly, techniques described herein support recurring on-chain transfers.

A client application may receive user inputs to initiate authorization of a recurring on-chain transfer. For example, the client application may display a user interface and, after displaying the user interface, receive user inputs to set up a recurring transfer of an amount of a crypto token from a first blockchain address of the user to a second blockchain address of a client of the client application. The client application may communicate with a blockchain address application that is associated with the first blockchain address of the user to authorize the recurring on-chain transfer. For example, the client application may transmit a payload for signature at the blockchain address application by the user. The signature of the user may authorize the recurring on-chain transfer. A smart contract may store the authorization of the recurring on-chain transfer and facilitate, at each instance of the on-chain transfer, the transfer of the amount of the crypto token from the first blockchain address to the second blockchain address. That is, the client application may call the smart contract at each instance of the on-chain transfer to initiate the transfer.

Techniques described herein may support reduced resource overhead compared to individual execution of on-chain transfers on a recurring basis. For example, by allowing the user to configure and authorize multiple instances of a recurring on-chain transfer, the client application may reduce a quantity of messages exchanged between the client application and the blockchain application. That is, rather than transmitting a message to the blockchain application requesting authorization for each transfer individually, the client application may transmit a single message requesting authorization (e.g., signature of a transaction) for multiple instances of the recurring on-chain transfer. Accordingly, the client application may reduce resource overhead by requesting the authorization for multiple instances of the recurring on-chain transfer. Additionally, repeatedly opening a blockchain address application is an undesired user experience and may result in increased computing resource overhead at the user device, as the user device has to load the blockchain address application into memory, facilitate generation and signature of a transaction, and transmit the transaction. The techniques described herein limit or reduce the need for loading the blockchain address into user device memory for transfer facilitation.

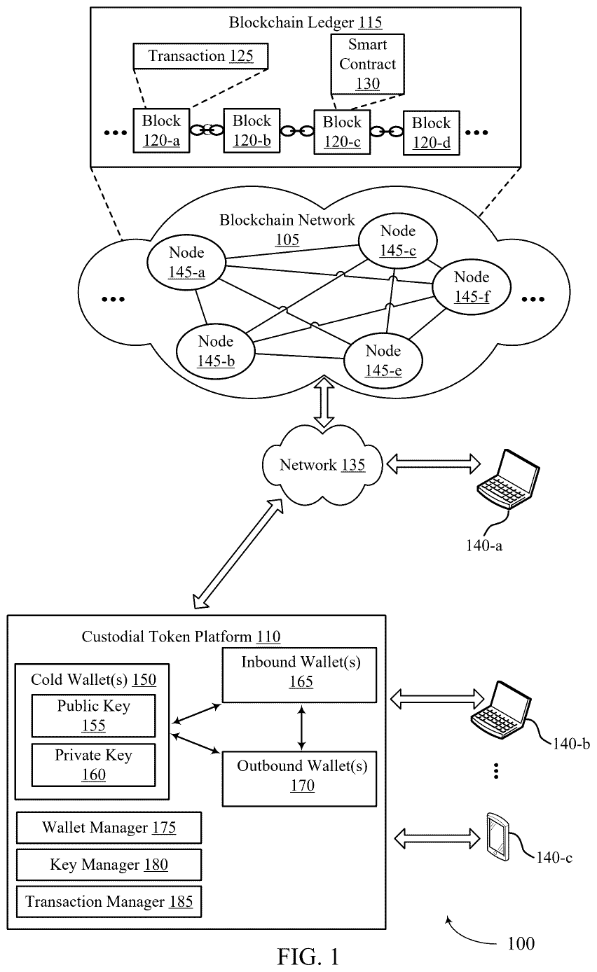

FIG. 1 illustrates an example of a computing environment 100 that supports recurring on-chain transfers in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the mart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

An application associated with the custodial token platform 110 or a standalone client application, such as a client application, may receive user inputs to initiate authorization of a recurring on-chain transfer. For example, the client application may receive user inputs via a user interface to set up a recurring transfer of an amount of a crypto token from a first blockchain address of the user to a second blockchain address of a client of the client application. The client application may communicate with a blockchain address application that is associated with the first blockchain address of the user to authorize the recurring on-chain transfer. For example, the client application may transmit a payload for signature at the blockchain address application by the user. The signature of the user (e.g., the private key of the blockchain address) may authorize the recurring on-chain transfer. A smart contract may store the authorization of the recurring on-chain transfer and facilitate, at each instance of the on-chain transfer, the transfer of the amount of the crypto token from the first blockchain address to the second blockchain address via the blockchain network 105. That is, the client application may call the smart contract at each instance of the on-chain transfer to initiate the transfer.

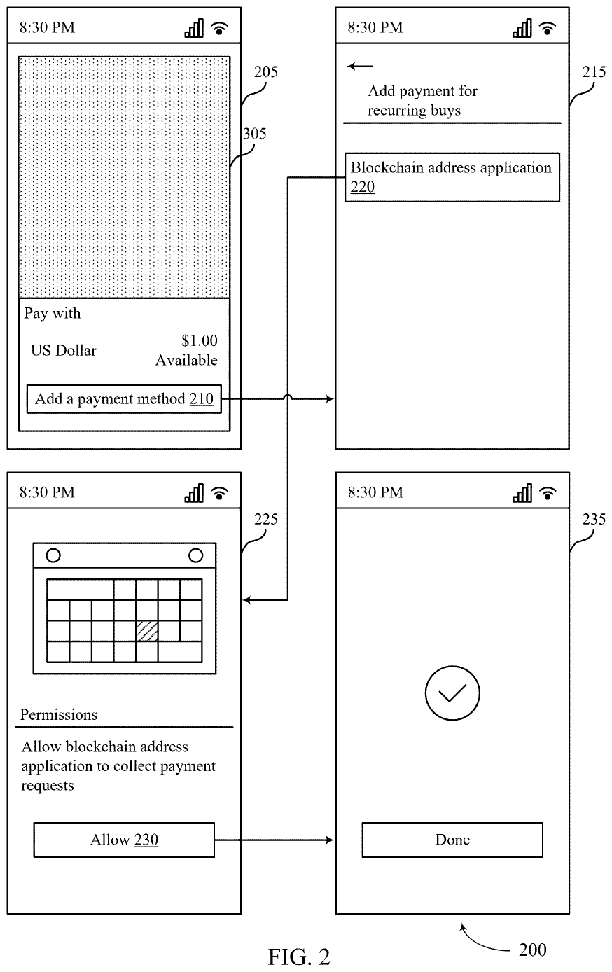

FIG. 2 shows an example of a user interface flow 200 that supports recurring on-chain transfers in accordance with aspects of the present disclosure. In some examples, the user interface flow 200 may implement or be implemented by aspects of the computing environment 100. For example, the user interface flow 200 may illustrate a display of one or more indications at a client application and a blockchain address application on a computing device, such as on the computing device 140 as described with reference to FIG. 1. Alternative examples of the following user interface flow may be implemented, where display of some indications may be in a different order than described or are not displayed at all. The user interface flow 200 may include additional indications not mentioned below, or further indications may be added. The user interface flow 200 illustrates examples user interfaces for initial setup for recurring on-chain transfers. That is, the operations of the process flow user interface flow 200 may be performed once for a given client (e.g., merchant). The operations of the user interface flow 200 may enable the client 410 to receive or configure recurring on-chain transfers.

The user interfaces of the user interface flow 200 may display one or more elements to support configuration of a recurring on-chain transfer. For example, the user interface flow 200 may illustrate and describe information displayed and user inputs obtained by different applications on a computing device to enable a user to initiate recurring on-chain transfers. Additionally, the user interface flow 200 may illustrate and describe information displayed and user inputs obtained to support authorization of a payment method for recurring on-chain transfers.

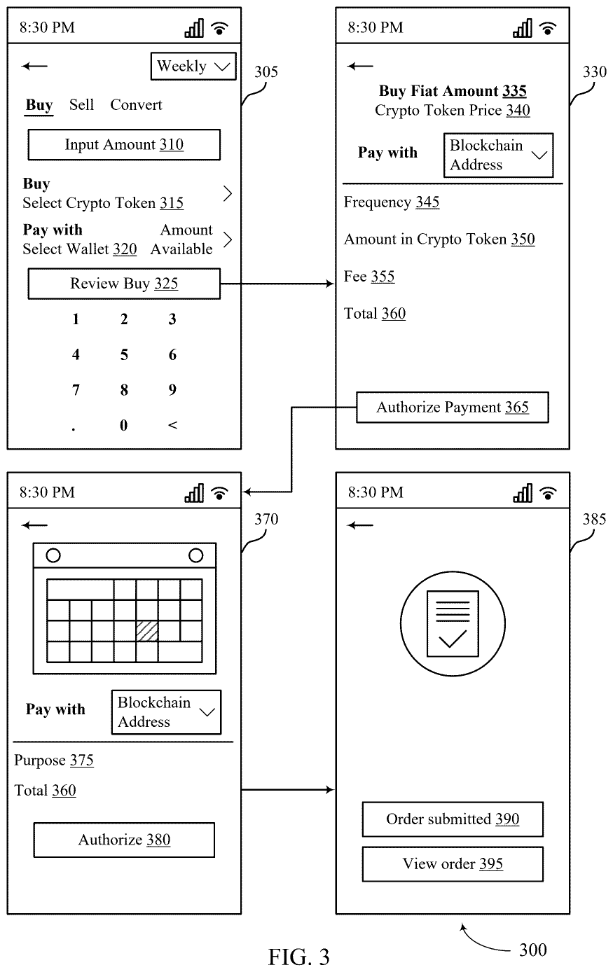

One or more operations may occur between and at other entities at a same time as or in response to operations illustrated and described with reference to the user interface flow 200. For example, the process flows described with reference to FIGS. 3 through 6B may illustrate and describe operations between entities (e.g., at the client application and the blockchain address application, on the blockchain network, on smart contracts, etc.) that correspond to or are triggered by various operations illustrated and described with reference to the user interface flow 200.

A user interface 205 may display a pop-up including an option to add a payment method 210. The user interface 205 may include the pop-up in accordance with a user lacking prior approval for a payment method for recurring on-chain transfers. That is, before configuring a recurring on-chain transfer, the user may add a payment method. The pop-up including the option to add a payment method 210 may be displayed in front of a user interface 305, which may be described in greater detail elsewhere herein, including with reference to FIG. 3.

After selection of the option to add the payment method 210, a user interface 215 may display an option to select a blockchain address application 220. In some examples, the user interface 215 may display multiple options of multiple different blockchain address applications from which a user may select the payment method for recurring on-chain transfers. In the example of FIG. 2, the user interface 215 may display the single option to select the blockchain address application 220 which, when selected, may cause the blockchain address application to open on the computing device.

A user interface 225 of the blockchain address application may indicate permissions associated with enabling a blockchain address as a payment method for recurring on-chain transfers. The permissions may indicate whether the recurring on-chain transfers involve approval by the user or are automatic (e.g., do not require approval by the user). The user interface 225 may include an option to allow 230 the blockchain address to be added as the payment method. Allowing the blockchain address to be added as a payment method may be referred to herein as approving a recurring payment mandate. In response to selection of the option to allow, the computing device may route the user back to the client application, where a user interface 235 may indicate that the payment method has been successfully added.

FIG. 3 shows an example of a user interface flow 300 that supports recurring on-chain transfers in accordance with aspects of the present disclosure. In some examples, the user interface flow 300 may implement or be implemented by aspects of the computing environment 100. For example, the user interface flow 300 may illustrate a display of one or more indications at a client application and a blockchain address application on a computing device, such as on the computing device 140 as described with reference to FIG. 1. Alternative examples of the following user interface flow may be implemented, where display of some indications may be in a different order than described or are not displayed at all. The user interface flow 300 may include additional indications not mentioned below, or further indications may be added.

The user interfaces of the user interface flow 300 may display one or more elements to support configuration of a recurring on-chain transfer. For example, the user interface flow 300 may illustrate and describe information displayed and user inputs obtained by different applications on a computing device to configure parameters of a recurring on-chain transfer (e.g., an amount, payment methods, blockchain addresses, frequency, etc.). Additionally, the user interface flow 300 may illustrate and describe information displayed and user inputs obtained to support authorization of the recurring on-chain transfer (e.g., on the blockchain network). For example, operations described with reference to the user interface flow 300 may cause one or more operations on a blockchain network, such as the blockchain network 105 as described with reference to FIG. 1. That is, inputs provided by a user via user interfaces of the user interface flow 300 may initiate the recurring on-chain transfer via the blockchain network 105.

One or more operations may occur between and at other entities at a same time as or in response to operations illustrated and described with reference to the user interface flow 300. For example, the process flows described with reference to FIGS. 3 through 6B may illustrate and describe operations between entities (e.g., at the client application and the blockchain address application, on the blockchain network, on smart contracts, etc.) that correspond to or are triggered by various operations illustrated and described with reference to the user interface flow 300.

A user interface 305 may display one or more elements to support input of information configuring a recurring on-chain transfer. For example, the user interface 305 may include an option to select a frequency or periodicity of the recurring on-chain transfer (e.g., “weekly” in the example of FIG. 3). Examples of frequencies or periodicities of the recurring on-chain transfer may include weekly, bi-weekly, monthly, yearly, or the like. Additionally, the option to select the frequency or periodicity of the recurring on-chain transfer may include an option to specify a day of the week in the case of weekly transfers, a day of the month in the case of monthly transfers, or the like. Additionally, the user interface 305 may include options to select blockchain addresses and amounts involved in the recurring on-chain transfer. For example, the user interface 305 may include option to input an amount 310, an option to select a crypto token 315, an option to select a wallet 320, and an option to review a buy 325.

As used herein, the recurring on-chain transfer may refer to a transfer of a first amount of a first crypto token from a first blockchain address associated with a blockchain application to a second blockchain address. For example, a user of the blockchain application (e.g., a merchant or client on a client application) may purchase the first amount of the first crypto token with a second amount of a second crypto token or a fiat. In other words, the recurring on-chain transfer may facilitate or support a purchase (e.g., buy) of the second amount of the second crypto token (e.g., the selected crypto token 315) using a first amount of the first crypto token or fiat (e.g., using the selected wallet 320). The second amount of the second crypto token may be transferred from the second blockchain address (e.g., of the merchant or client) to the first blockchain address (e.g., a wallet of the user). Additionally, the first amount of the second crypto token or fiat may be transferred from the first blockchain address of the user (e.g., the selected wallet 320) to the second blockchain address or an external account (e.g., off-chain, such as in the case of fiat) of the client. The input amount 310 may refer to the second amount of the second crypto token. In some examples, the user interface 305 may display the input amount 310 as a fiat amount, where the second amount corresponds to the input amount 310 of the fiat according to an exchange rate.

The user may set up a payment method for recurring payments prior to configuring the recurring on-chain transfer (e.g., before selecting review buy 325). In the example of FIG. 3, the user may set up a blockchain address for recurring on-chain transfers by selecting the option to select the wallet 320. In examples in which the user does not have a blockchain address that is authorized for recurring on-chain transfers, selection of the option to select the wallet 320 may cause display of an option to add a blockchain address for the recurring on-chain transfers (not shown). For example, the user interface may display indications of one or more blockchain addresses of the user that are capable of supporting the recurring on-chain transfers. In other words, the client application, via the user interface, may display one or more blockchain addresses with associated blockchain address applications as supported payment methods for recurring buys.

Selection of a blockchain address of the one or more blockchain addresses may cause a blockchain address application to open on the computing device. For example, when the user selects a payment method, the user may be redirected to the blockchain address application (e.g., a blockchain wallet application) to approve a recurring payment mandate. The user may select, via the blockchain address application associated with the selected blockchain address, an option to allow recurring on-chain transfer requests at the blockchain address application. Selection of the option to allow the recurring on-chain transfer requests may cause the client application to open on the computing device (e.g., redirecting the user to the client application). The client application may display a confirmation of the authorization completed at the blockchain address application. In other words, once the recurring payment mandate is approved, the payment method may be ready to be used for recurring payments.

After receiving a user input selecting the option to review the buy 325, a user interface 330 may display a summary of the recurring on-chain transfer. For example, the user interface 330 may include a buy fiat amount 335 (e.g., the input amount 310 from the user interface 305), a crypto token price 340, a frequency 345 (e.g., “weekly”), an amount in a crypto token 350 (e.g., corresponding to the buy fiat amount 335), a fee 355 (e.g., for the blockchain address application), and a total 360. Additionally, the user interface 330 may include an option to authorize the payment 365. The user may provide, via the user interface 330, an input to authorize the payment 365 based on the summarized display of the recurring on-chain transfer.

After receiving the input to authorize the payment 365, the user may be routed to the blockchain address application associated with the selected blockchain address (e.g., the selected wallet 320). For example, the input to authorize the payment 365 may cause the blockchain address application to open on the computing device. Additionally, or alternatively, the computing device may display a push notification indicating that the recurring on-chain transfer is pending authorization. A user interface 370 of the blockchain address application may include information associated with the recurring on-chain transfer and an option to authorize 380 the recurring on-chain transfer. For example, the user interface 370 may include a purpose 375 (e.g., “crypto token buy”) and the total 360. The authorization may set up the recurring on-chain transfer to be executed at the frequency 345 and complete (e.g., execute on the blockchain network) a first instance of the recurring on-chain transfer. In some examples, the authorization may include pre-authorization of multiple instances of the recurring on-chain transfer. For example, the authorization may represent execution of a signature that authorizes at least the first instance of the recurring on-chain transfer or multiple signatures authorizing multiple instances of the recurring on-chain transfer. After selection of the option to authorize 380, the user may be re-routed to the client application where a confirmation of the recurring on-chain payment may be displayed. For example, the user interface 382 of the client application may display an indication that the order is submitted 390 and an option to view the order 395 (e.g., view details of the order, such as the information included in the user interface 330).

At each instance of the recurring on-chain transfer (e.g., each week in the example of FIG. 3), the user may receive a push notification indicating that the recurring on-chain transfer is pending authorization, which may route the user to the user interface 370 to authorize the instance of the recurring on-chain transfer (e.g., in examples in which the user authorizes the recurring on-chain transfers individually). Alternatively, the push notification may indicate that the recurring on-chain transfer has occurred, such as in examples in which the user completed authorization (e.g., pre-authorization or produced signatures prior) for multiple instances of the recurring on-chain transfer.

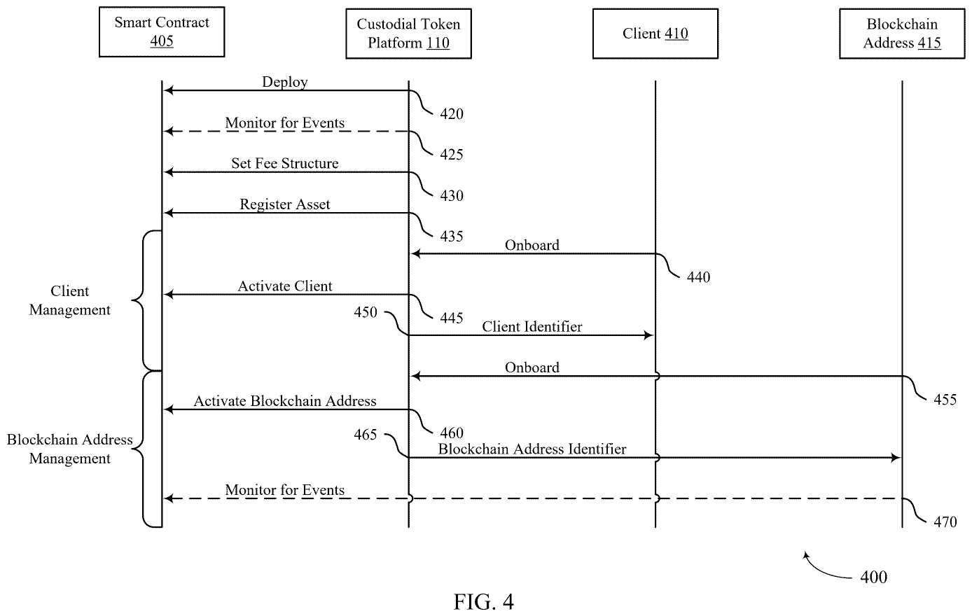

FIG. 4 shows an example of a process flow 400 that supports recurring on-chain transfers in accordance with aspects of the present disclosure. In some examples, the process flow 400 may implement or be implemented by the computing environment 100, the user interface flow 300, or both. For example, the process flow 400 may include a smart contract 405, a custodial token platform 110, a client 410, and a blockchain address 415, which may be examples of the corresponding devices or systems as described with reference to FIGS. 1 and 2. Specifically, the process flow 400 illustrates examples operations for initial setup for recurring on-chain transfers. That is, the operations of the process flow 400 may be performed once for a given client (e.g., merchant). The operations of the process flow 400 may enable the client 410 to receive or configure recurring on-chain transfers.

Alternative examples of the following may be implemented, where some operations are performed in a different order than described or are not performed at all. In some cases, operations may include additional features not mentioned below, or further operations may be added. Although the smart contract 405, the custodial token platform 10, the client 410, and the blockchain address 415 are shown performing the operations of the process flow 400, some aspects of some operations may also be performed by one or more other components.

At 420, the custodial token platform 110 may deploy the smart contract 405. In the example of FIG. 4, the custodial token platform 110 may be an example of a central entity that manages deployment and event monitoring for the smart contract 405. That is, the custodial token platform 110 may be an example of the custodial token platform 110 as described with reference to FIG. 1 or an example of another entity that manages a smart contract.

At 425, the custodial token platform 110 may monitor for events on the smart contract 405. In other words, the custodial token platform 110 may listen to events that occur on the smart contract 405 for reporting, such as reporting to one or more other entities, including the client 410 and the blockchain address 415. While the monitoring is shown as occurring at 425, it may be understood that the custodial token platform 110 may continuously or periodically monitor events on the smart contract 405, such as throughout the operations of the process flow 400.

The custodial token platform 110 may register fee structure and assets in the smart contract 405. For example, at 430, the custodial token platform 110 may set a fee structure at the smart contract 405. At 445, the custodial token platform 110 may register an asset at the smart contract 405. As an example, the custodial token platform 110 may configure the smart contract 405 to support recurring on-chain transfers of different types of crypto tokens. In some examples, registering the asset at the smart contract may involve providing a smart contract address that the smart contract 405 can execute or call to transfer tokens.

After deploying the smart contract 405 and configuring parameters at the smart contract 405, the custodial token platform 110 may perform client management to onboard the client 410. For example, at 440, the client 410 may perform, via the custodial token platform 110, an onboarding procedure. The custodial token platform 110 may proceed to activate the client 410 at the smart contract 405 at 445. In other words, the custodial token platform 110 may register or otherwise configure the client 410 to be available for recurring on-chain transfers via the smart contract 405. After activating the client 410 at the smart contract 405, the custodial token platform 110 may obtain and indicate, to the client 410 at 450, a client identifier. Indication of the client identifier may indicate completion of the onboarding. In other words, the client 410 may receive, after completion of the onboarding procedure, a client identifier. The client 410 may use the client identifier for the recurring on-chain transfers via the smart contract 405. That is, initiating a payload for signature to complete a recurring on-chain transfer via the smart contract 405 may be based on the client identifier.

Additionally, the custodial token platform 110 may perform wallet management to onboard the blockchain address 415. For example, the blockchain address 415 may be an address of a blockchain address application that is associated with private keys used to sign and execute transactions via a blockchain network, such as the blockchain network 105 as described with reference to FIG. 1. The blockchain address application may use the blockchain address 415 to collect fees involved in recurring on-chain transfers, among other operations on the blockchain network. The blockchain address 415 may be understood to be the same as or have similar functions to a wallet as described with reference to FIG. 1.

At 455, the blockchain address 415 may perform an onboarding procedure via the custodial token platform 110, and the custodial token platform 110 may proceed to activate the blockchain address 415 at the smart contract 405 at 460. In other words, the custodial token platform 110 may register or otherwise configure the blockchain address 415 to be available for fee collection by a blockchain address application for recurring on-chain transfers via the smart contract 405. After activating the blockchain address 415 at the smart contract 405, the custodial token platform 110 may obtain and indicate, to the blockchain address 415 at 465, a blockchain address identifier. Indication of the blockchain address identifier may indicate completion of the onboarding. The blockchain address 415 may use the blockchain address identifier for the recurring on-chain transfers via the smart contract 405. For example, the blockchain address identifier may reference activation of the blockchain address 415 at the smart contract 405. After registration at the smart contract 405, the blockchain address 415 may monitor for events on the smart contract 405. In other words, the blockchain address 415 may listen to events for payment processing.

In some implementations, the custodial token platform 110 may deploy an application programming interface (API) and a recurring transfer receive address to support recurring transfers. For example, the custodial token platform 110 may deploy the API in place of the smart contract 405, where the API may perform same or similar operations as the smart contract 405 in an off-chain manner. In other words, rather than storing information (e.g., the fee structure, registrations for assets, activations of clients and blockchain addresses) on the blockchain network, the API may store the information off-chain. In such examples, the custodial token platform 110 may use the recurring transfer receive address to settle recurring transfers in batches. For example, payments for recurring transfers from multiple blockchain addresses may route through the recurring transfer receive address to different clients (e.g., merchants).

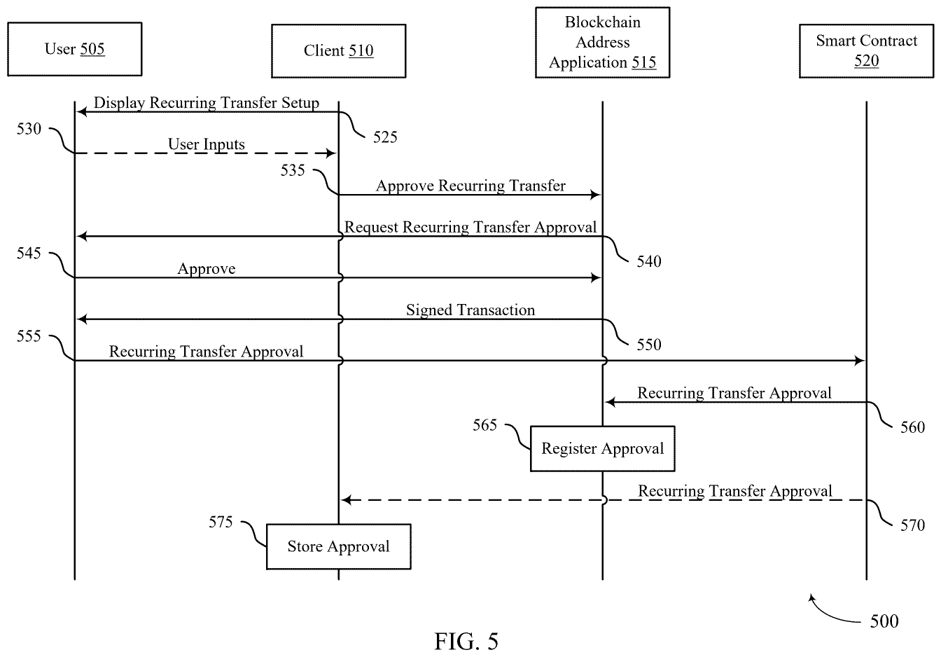

FIG. 5 shows an example of a process flow 500 that supports recurring on-chain transfers in accordance with aspects of the present disclosure. In some examples, the process flow 500 may implement or be implemented by the computing environment 100, the user interface flow 300, or both. For example, the process flow 500 may include a user 505, a client 510, a blockchain address application 515, and a smart contract 520, which may be examples of the corresponding devices or systems as described with reference to FIGS. 1 and 2. The client 510 may be an example of a website accessible via a browser, web-service, or standalone application.

Alternative examples of the following may be implemented, where some operations are performed in a different order than described or are not performed at all. In some cases, operations may include additional features not mentioned below, or further operations may be added. Although the user 505, the client 510, the blockchain address application 515, and the smart contract 520 are shown performing the operations of the process flow 500, some aspects of some operations may also be performed by one or more other components.

The process flow 500 may illustrate and describe operations between different entities that support configuration of a recurring on-chain transfer. For example, the process flow 500 may illustrate and describe operations that correspond to the elements displayed via the user interfaces of the user interface flow 300. Additionally, or alternatively, the process flow 500 may illustrate and describe operations between the smart contract 520 that is deployed for recurring on-chain transfers, a client 510 that is registered to perform recurring on-chain transfers, or both, which may be examples of smart contracts and clients described with reference to FIG. 4.

At 525, the client 510 may display a recurring transfer setup to the user 505. For example, the client 510 may display the recurring transfer setup via a user interface of a client application, such as via the user interface 305 as described with reference to FIG. 3. At 530, the user 505 may provide user inputs to the client 510 via the user interface. That is, the user 505 may provide inputs to set up the recurring on-chain transfer, including the parameters illustrated and described with reference to the user interface 305 of FIG. 3. In other words, the client 510 may receive one or more user inputs to initiate authorization of multiple instances of a transfer of a second amount of a second crypto token from a second blockchain address (e.g., of the user 505) to a first blockchain address. That is, the client 410 may receive one or more user inputs to initiate authorization of a recurring buy.

At 535, the client 510 may send a message to the blockchain address application 515 (e.g., a frontend) to approve the recurring transfer. In other words, the client 510 may transmit, to the blockchain address application 515 after receiving the one or more user inputs, a payload for signature at the blockchain address application 515 and for registration, via the smart contract 520, of the authorization of the multiple instances of the transfer. The message may be an example of an approve mandate send and, in some examples, may be sent via Web3 (e.g., via a decentralized network, such as the blockchain network 105 as described with reference to FIG. 1). The message may include a client identifier (e.g., the client identifier described with reference to FIG. 4), a mandate reference, an identifier of a crypto token (e.g., an asset identifier), and other metadata describing the mandate. As used herein, a “mandate” may refer to a recurring on-chain transfer.

At 540, the blockchain address application 515 (e.g., a frontend) may request recurring transfer approval from the user 505. That is, after receiving the message to approve the recurring transfer from the client 510, the blockchain address application 515 may seek approval (e.g., a signature) from the user 505 to authorize the recurring transfer (e.g., seek mandate approval). For example, the blockchain address application 515 may include a request to sign the mandate. At 545, the user 505 may provide approval to the blockchain address application 515 (e.g., a frontend). For example, the user 505 may sign the mandate transaction via a private key of a wallet. The approval request and subsequent approval by the user may be an example of the authorization request and approval illustrated and described with reference to the user interface 370 of FIG. 3. After receiving the approval, at 550, the blockchain address application 515 (e.g., a frontend) may indicate a signed transaction (e.g., the signed mandate transaction) to the user 505.

At 555, the user 505 broadcast the recurring transfer approval to the smart contract 520. For example, the user 505 may broadcast, via a blockchain network, the signed mandate approval transaction to the smart contract 520 such that approval of the recurring on-chain transaction is stored at the smart contract 520. The blockchain address application 515 (e.g., a backend), after the user 505 broadcasts the transaction and at 560, may receive an indication of or otherwise identify that the mandate approval has occurred. At 565, the blockchain address application 515 (e.g., a backend) may register the approval. In other words, the blockchain address application 515 may store the approval. Additionally, or alternatively, the client 510, after the user 505 broadcasts the transaction and at 570, may receive an indication of or otherwise identify that the mandate approval has occurred. For example, the client 510 may receive, after initiating the registration via the smart contract 520, a message indicating that the registration is complete in accordance with an approval event on the blockchain network. At 575, the client 510 may store the approval. For example, the client 510 may store the message indicating that the registration is complete. That is, the blockchain address application 515 and the client 510 may monitor the smart contract 520 for the approval of the recurring transfer and, after identifying the approval, store the approval.

In some examples, the user 505 may revoke or delete the recurring on-chain transfer. For example, the user 505 may provide one or more inputs to the blockchain address application 515 to delete the recurring on-chain transfer (e.g., delete the mandate). In response to the one or more inputs to delete the recurring on-chain transfer, the blockchain address application 515 may request that the user 505 signs a delete recurring transfer transaction. The user 505 may sign the delete recurring transfer transaction (e.g., via a private key) and broadcast the delete recurring transfer transaction to the smart contract 520. The blockchain address application 515 and the client 510 may identify the delete recurring transfer transaction on the smart contract 520 and store the deletion. The blockchain address application 515, the client 510, or both may refrain from initiating instances of the recurring on-chain transfer after identifying the deletion. In other words, the client 510 may receive a message indicating that the authorization of one or more instances of the multiple instances is revoked and refrain from initiating, at a second instance of the multiple instances, the transfer after receiving the message.

One or more of the messages described with reference to FIG. 5 may represent messages broadcast via a blockchain network, such as on-chain messages. In some implementations, the devices and systems of FIG. 5 may exchange off-chain messages. For example, in examples in which an API is deployed (e.g., in place of the smart contract 520), the messages described with reference to FIG. 5 may represent API calls and off-chain messages. In such examples, when the user 505 approves or signs the recurring transfer approval, the blockchain address application 515 makes a call to the API registering that the mandate has been approved by passing the signed message. The API may send a webhook to the client 510 that the mandate is registered that the client 510 can use the initiate payment requests. Additionally, the API may send a webhook to the blockchain address application 515 (e.g., a backend).

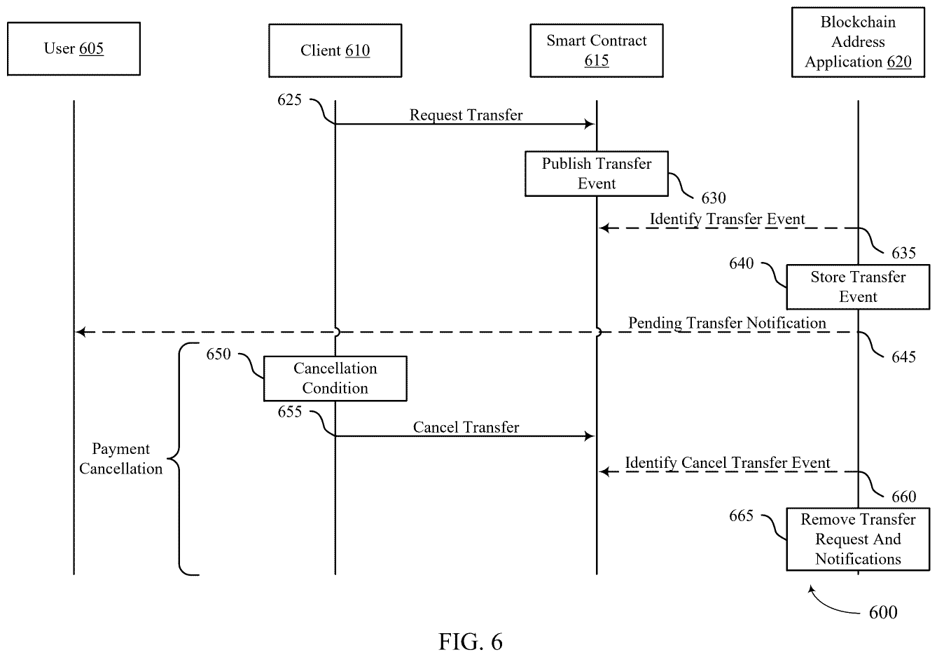

FIG. 6 shows an example of a process flow 600 that supports recurring on-chain transfers in accordance with aspects of the present disclosure. In some examples, the process flow 600 may implement or be implemented by the computing environment 100, the user interface flow 300, or both. For example, the process flow 500 may include a user 605, a client 610, a smart contract 615, and a blockchain address application 620, which may be examples of the corresponding devices or systems as described with reference to FIGS. 1 and 2.

Alternative examples of the following may be implemented, where some operations are performed in a different order than described or are not performed at all. In some cases, operations may include additional features not mentioned below, or further operations may be added. Although the user 605, the client 610, the smart contract 615, and the blockchain address application 620 are shown performing the operations of the process flow 600, some aspects of some operations may also be performed by one or more other components.

The process flow 600 may illustrate and describe initiation of a recurring payment by the client 610 via the smart contract 615. For example, at an instance of multiple instances of a recurring on-chain transfer, the client 610 may request the transfer from the smart contract 615 to initiate execution of the transfer via a blockchain network. At 625, the client 610 may request the transfer from the smart contract 615. For example, the client 610 may broadcast one or more messages to call the smart contract 615, where the one or more messages are configured to trigger an instance of the multiple instances of the transfer of the first amount of the first crypto token from the first blockchain address to the second blockchain address on a blockchain network by referencing the registration (e.g., of the authorization). The request may include the client identifier (e.g., described with reference to FIG. 4), a transfer reference, an amount, and other metadata describing the transfer. In other words, the request may include information associated with the recurring on-chain transfer (e.g., the mandate) approved previously by the user 605, such as the approval described with reference to FIG. 5. At 630, after receiving the request, the smart contract 615 may publish a transfer event. That is, the smart contract 615 may execute, via the blockchain network, the recurring on-chain transfer that was previously configured and approved by the user 605.

At 635, the blockchain address application 620 may identify a transfer event. For example, the blockchain address application 620 may identify that the smart contract 615 executed the recurring on-chain transfer via the blockchain network. As an example, the blockchain address application 620 may identify the transfer on a blockchain ledger of the blockchain network, based on monitoring the smart contract 615, or both. The blockchain address application 620 may store the transfer event at 640 and notify the user 605 of the transfer at 645.

In some examples, the blockchain address application 620 may seek approval from the user 605 for the instance of the recurring on-chain transfer. That is, in examples in which the user 605 did not pre-sign for multiple instances of the recurring on-chain transfer, the pending transfer notification at 645 may request the user to sign and broadcast a transaction to the smart contract 615 via the blockchain network. Approval for the instance of the recurring on-chain transfer may be described in greater detail elsewhere herein, including with reference to FIG. 6A. Alternatively, the blockchain address application 620 may notify the user 605 (e.g., without seeking approval) of the instance of the recurring on-chain transfer. In other words, the blockchain address application 620 may seek approval or otherwise notify the user 605 of the transfer based on whether the user 605 pre-signed multiple instances of the recurring on-chain transfer. In some examples, the blockchain address application 620 may additionally transmit reminder notifications to the user 605.

At 650, the client 610 may identify a cancellation condition. That is the client 610 may identify a cancellation condition associated with the authorization, the cancellation condition indicated by the one or more user inputs (e.g., received at 530 of FIG. 5). For example, the client 610 may identify that the instance of the recurring on-chain transfer has timed out. In such examples, the client 610 may transmit a request to cancel the transfer to the smart contract 615 at 655. That is, the client 610 may transmit a message to cancel at least one instance of the multiple instances via the smart contract 520. The smart contract 615 may publish the cancellation event. That is, the smart contract 615 may execute, via the blockchain network, a cancellation of the recurring on-chain transfer. At 660, the blockchain address application 620 may identify the cancel transfer event and, at 665, may remove the transfer request and notifications.

One or more of the messages described with reference to FIG. 6 may represent messages broadcast via a blockchain network, such as on-chain messages. In some implementations, the devices and systems of FIG. 6 may exchange off-chain messages. For example, in examples in which an API is deployed (e.g., in place of the smart contract 615), the messages described with reference to FIG. 6 may represent API calls and off-chain messages. In such examples, using an approved mandate, the client 610 can initiate a payment collection request by calling the API. Calling the API may send a webhook to the blockchain address application 620 (e.g., a backend) that initiates the process for seeking approval for payment from the user 605. The blockchain address application 620 (e.g., a frontend) may send notifications (and reminder notifications) to the user 605 about pending transfers.

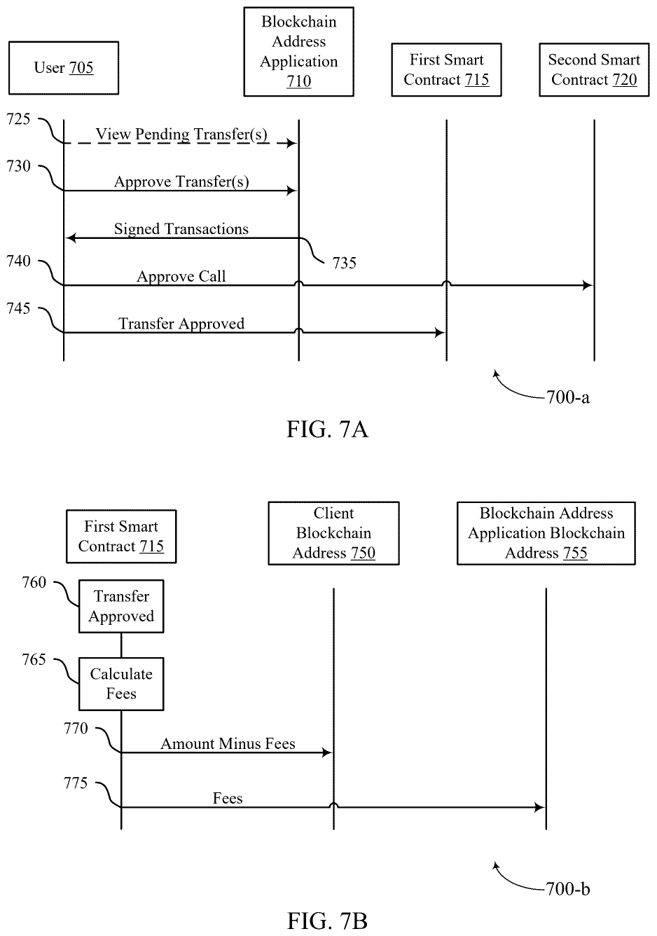

FIG. 7A shows an example of a process flow 700-a that supports recurring on-chain transfers in accordance with aspects of the present disclosure. In some examples, the process flow 700-a may implement or be implemented by the computing environment 100, the user interface flow 300, or both. For example, the process flow 700-a may include a user 705, a blockchain address application 710, a first smart contract 715, and a second smart contract 720, which may be examples of the corresponding devices or systems as described with reference to FIGS. 1 and 2. The first smart contract 715 may be an example of the smart contract 405 that is deployed for management of recurring on-chain transfers.

Alternative examples of the following may be implemented, where some operations are performed in a different order than described or are not performed at all. In some cases, operations may include additional features not mentioned below, or further operations may be added. Although the user 705, the blockchain address application 710, the first smart contract 715, and the second smart contract 720, are shown performing the operations of the process flow 700-a, some aspects of some operations may also be performed by one or more other components.

The user 705 may approve pending transfers via the blockchain address application 710. For example, at 725, the user 705 may view pending transfer(s) on the blockchain address application 710. The pending transfer(s) may include one or more instances of the recurring on-chain transfer. In some examples, the user 705 may view the pending transfer(s) after being notified of the pending transfers, such as after the notification at 645 of FIG. 6. The user 705 may approve one or more of the pending transfer(s) at 730. For example, the user 705 may generate one or more signatures using a private key of a blockchain address to approve a transfer. Approving a pending transfer may include signing a first transaction (e.g., an Ethereum Request for Comment 20 (ERC-20)) such that the first smart contract 715 may transfer an amount of a crypto token involved in the recurring on-chain transfer from the blockchain address of the user 705. Additionally, approving the pending transfer may include signing a second transaction (e.g., an approve payment collection function) to call the first smart contract 715 to initiate a settlement.

At 735, the blockchain address application 710 may indicate the signed transactions to the user 705. At 740, the user 705 may transmit an approve call to the second smart contract 720 (e.g., an asset smart contract). At 745, the user 705 may indicate transfer approval to the first smart contract 715. For example, the user 705 may broadcast one or more messages indicating the signed first and second transactions via the blockchain network. The one or more messages may include an identifier of the blockchain address of the user 705 (e.g., the blockchain address associated with the private key used to generate the signatures).

One or more of the messages described with reference to FIG. 7A may represent messages broadcast via a blockchain network, such as on-chain messages. In some implementations, the devices and systems of FIG. 7A may exchange off-chain messages. For example, in examples in which an API is deployed (e.g., in place of the first smart contract 715), the messages described with reference to FIG. 7A may represent API calls and off-chain messages. In such examples, the recurring on-chain transfers may be made to a recurring transfers receive address (e.g., as described with reference to FIG. 4). After the user 705 signs the transaction, as part of the signing process, the wallet of the user 705 may also call the API to indicate that the transfer has been approved. The API call may include a hash of the transaction such that the API may store the transaction and monitor its status on the blockchain network. After the transaction is broadcasted and confirmed on-chain, the API may queue the payment for settlement.

Settlement may involve the API sending transfers to receive addresses of the client, the blockchain address application, or both. For example, at a regular cadence, the API may initiate batch settlement of the transfers that are pending settlement. As part of the batch settlement process, the API may calculate an aggregated amount to settle to each client and aggregated fees to send to each blockchain address application. The settlement amount and fees are then sent on-chain from the recurring payments receive address to client and blockchain address application addresses, respectively. The API may also send a webhook to the client to indicate settlement. In some examples, the API may also send the webhook to the blockchain address application.

FIG. 6B shows an example of a process flow 700-b that supports recurring on-chain transfers in accordance with aspects of the present disclosure. In some examples, the process flow 700-b may implement or be implemented by the computing environment 100, the user interface flow 200, or both. For example, the process flow 700-b may include a first smart contract 715, a client blockchain address 750, and a blockchain address application blockchain address 755, which may be examples of the corresponding devices or systems as described with reference to FIGS. 1 and 2.

Alternative examples of the following may be implemented, where some operations are performed in a different order than described or are not performed at all. In some cases, operations may include additional features not mentioned below, or further operations may be added. Although the first smart contract 715, the client blockchain address 750, and the blockchain address application blockchain address 755, are shown performing the operations of the process flow 700-b, some aspects of some operations may also be performed by one or more other components.

The first smart contract 715 may execute the recurring on-chain transfer. For example, after the transfer is approved by the user 705 at 760 (e.g., corresponding to the transfer approved at 745 of FIG. 7A), the first smart contract 715 may calculate the fees at 765. The fees may be based on a fee structure set by an entity that deployed the first smart contract 715, such as the custodial token platform 110 as described with reference to FIG. 4.

At 770, the first smart contract 715 may transfer the amount (e.g., the amount of the recurring on-chain transfer) minus the fees to the client blockchain address 750. In other words, the client may receive, at the client blockchain address 750 and via the first smart contract 715, a second amount of the first crypto token, the second amount including the first amount minus a third amount of fees associated with the blockchain address application 710. Additionally, at 775, the first smart contract 715 may transfer the fees to the blockchain address application blockchain address 755. For example, the first smart contract 715 may execute, via the blockchain network, multiple transfers from a blockchain address of the user 705 to the client blockchain address 750 and to the blockchain address application blockchain address 755.

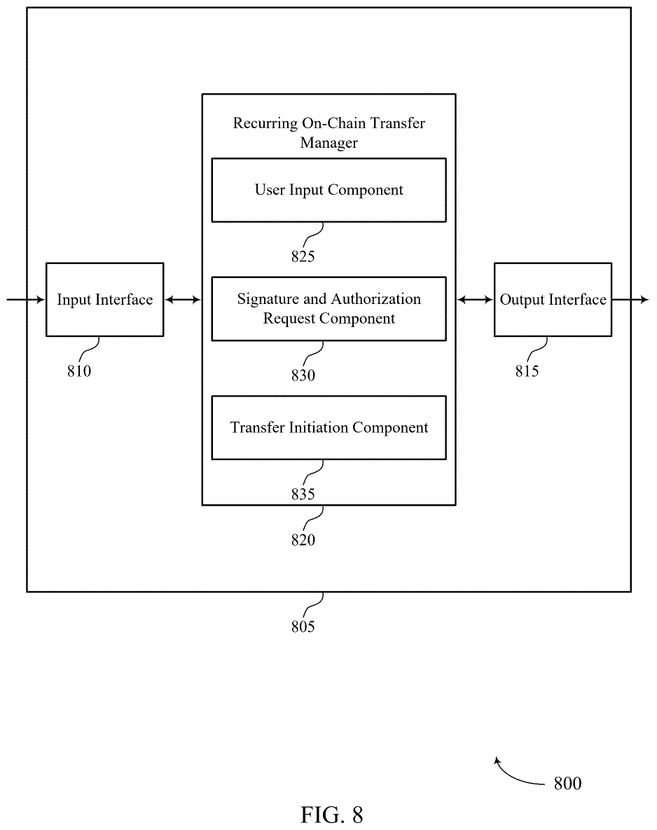

FIG. 8 shows a block diagram 800 of a system 805 that supports recurring on-chain transfers in accordance with aspects of the present disclosure. The system 805 may include an input interface 810, an output interface 815, and a recurring on-chain transfer manager 820. The system 805, or one or more components of the system 805 (e.g., the input interface 810, the output interface 815, the recurring on-chain transfer manager 820), may include at least one processor, which may be coupled with at least one memory, to support the described techniques. Each of these components may communicate, directly or indirectly, with one another (e.g., via one or more buses, communications links, communications interfaces, or any combination thereof).

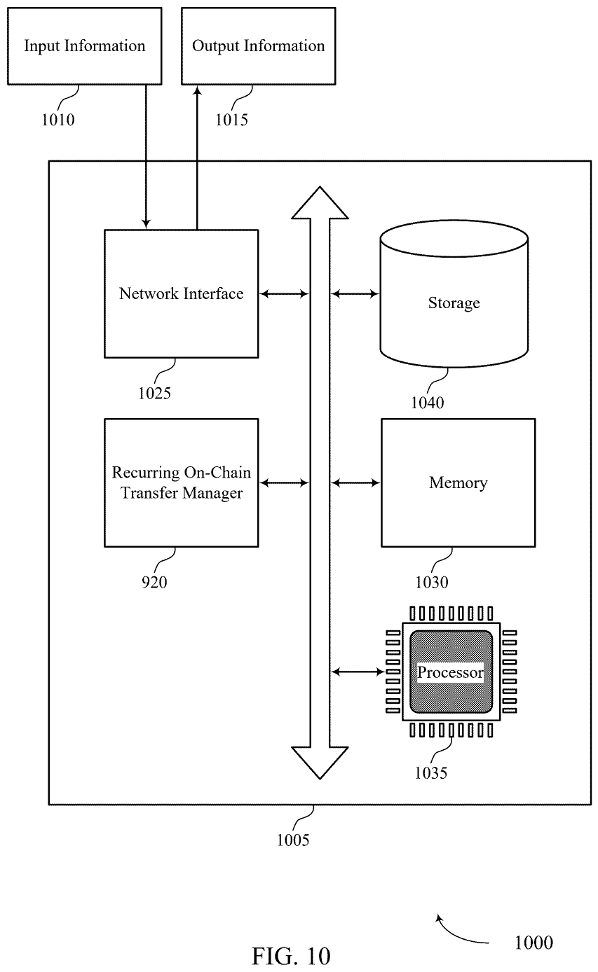

The input interface 810 may manage input signaling for the system 805. For example, the input interface 810 may receive input signaling (e.g., messages, packets, data, instructions, commands, transactions, or any other form of encoded information) from other systems or devices. The input interface 810 may send signaling corresponding to (e.g., representative of or otherwise based on) such input signaling to other components of the system 805 for processing. For example, the input interface 810 may transmit such corresponding signaling to the recurring on-chain transfer manager 820 to support recurring on-chain transfers. In some cases, the input interface 810 may be a component of a network interface 1025 as described with reference to FIG. 10.

The output interface 815 may manage output signaling for the system 805. For example, the output interface 815 may receive signaling from other components of the system 805, such as the recurring on-chain transfer manager 820, and may transmit such output signaling corresponding to (e.g., representative of or otherwise based on) such signaling to other systems or devices. In some cases, the output interface 815 may be a component of a network interface 1025 as described with reference to FIG. 10.

For example, the recurring on-chain transfer manager 820 may include a user input component 825, a signature and authorization request component 830, a transfer initiation component 835, or any combination thereof. In some examples, the recurring on-chain transfer manager 820, or various components thereof, may be configured to perform various operations (e.g., receiving, monitoring, transmitting) using or otherwise in cooperation with the input interface 810, the output interface 815, or both. For example, the recurring on-chain transfer manager 820 may receive information from the input interface 810, send information to the output interface 815, or be integrated in combination with the input interface 810, the output interface 815, or both to receive information, transmit information, or perform various other operations as described herein.

The recurring on-chain transfer manager 820 may support facilitating recurring on-chain transactions in accordance with examples as disclosed herein. The user input component 825 may be configured as or otherwise support a means for receiving one or more user inputs to initiate authorization of a plurality of instances of a transfer of a first amount of a first crypto token from a first blockchain address associated with a blockchain application to a second blockchain address. The signature and authorization request component 830 may be configured as or otherwise support a means for transmitting, to a blockchain address application after receiving the one or more user inputs, a payload for signature at the blockchain address application and for registration, via a smart contract, of the authorization of the plurality of instances of the transfer. The transfer initiation component 835 may be configured as or otherwise support a means for broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration.

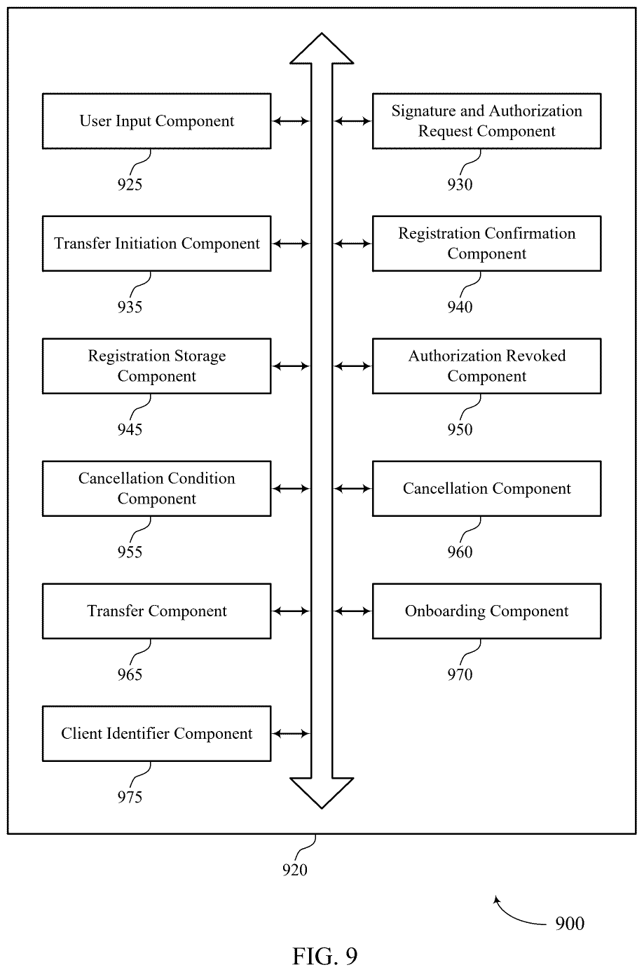

FIG. 9 shows a block diagram 900 of a recurring on-chain transfer manager 920 that supports recurring on-chain transfers in accordance with aspects of the present disclosure. The recurring on-chain transfer manager 920 may be an example of aspects of a recurring on-chain transfer manager or a recurring on-chain transfer manager 820, or both, as described herein. The recurring on-chain transfer manager 920, or various components thereof, may be an example of means for performing various aspects of recurring on-chain transfers as described herein. For example, the recurring on-chain transfer manager 920 may include a user input component 925, a signature and authorization request component 930, a transfer initiation component 935, a registration confirmation component 940, a registration storage component 945, an authorization revoked component 950, a cancellation condition component 955, a cancellation component 960, a transfer component 965, an onboarding component 970, a client identifier component 975, or any combination thereof. Each of these components may communicate, directly or indirectly, with one another (e.g., via one or more buses, communications links, communications interfaces, or any combination thereof).

The recurring on-chain transfer manager 920 may support facilitating recurring on-chain transactions in accordance with examples as disclosed herein. The user input component 925 may be configured as or otherwise support a means for receiving one or more user inputs to initiate authorization of a plurality of instances of a transfer of a first amount of a first crypto token from a first blockchain address associated with a blockchain application to a second blockchain address. The signature and authorization request component 930 may be configured as or otherwise support a means for transmitting, to a blockchain address application after receiving the one or more user inputs, a payload for signature at the blockchain address application and for registration, via a smart contract, of the authorization of the plurality of instances of the transfer. The transfer initiation component 935 may be configured as or otherwise support a means for broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration.

In some examples, to support transmitting the payload for the signature at the blockchain address application and the registration via the smart contract, the signature and authorization request component 930 may be configured as or otherwise support a means for transmitting a request message to the blockchain application, the request message comprising a client identifier, an authorization reference, an identifier of the first crypto token, and metadata associated with the authorization.

In some examples, to support broadcasting the one or more messages, the transfer initiation component 935 may be configured as or otherwise support a means for broadcasting a request message, the request message comprising an identifier of the registration, a transfer reference, the first amount of the first crypto token, and metadata associated with the transfer.

In some examples, the registration confirmation component 940 may be configured as or otherwise support a means for receiving, after initiating the registration via the smart contract, a message indicating that the registration is complete in accordance with an approval event on the blockchain network. In some examples, the registration storage component 945 may be configured as or otherwise support a means for storing the message indicating that the registration is complete, wherein broadcasting the one or more messages is based at least in part on storing the message indicating that the registration is complete.

In some examples, the authorization revoked component 950 may be configured as or otherwise support a means for receiving a message indicating that the authorization of one or more instances of the plurality of instances is revoked. In some examples, the transfer initiation component 935 may be configured as or otherwise support a means for refraining from initiating, at a second instance of the plurality of instances, the transfer after receiving the message indicating that the authorization of the one or more instances of the plurality of instances is revoked.

In some examples, the cancellation condition component 955 may be configured as or otherwise support a means for identifying a cancellation condition associated with the authorization, the cancellation condition indicated by the one or more user inputs. In some examples, the cancellation component 960 may be configured as or otherwise support a means for transmitting a message to cancel at least one instance of the plurality of instances via the smart contract.

In some examples, the cancellation condition comprises a transfer timeout.

In some examples, the transfer component 965 may be configured as or otherwise support a means for receiving, via the smart contract, a second amount of the first crypto token, the second amount comprising the first amount minus a third amount of fees associated with the blockchain application.

In some examples, the onboarding component 970 may be configured as or otherwise support a means for performing, via the blockchain application, an onboarding procedure. In some examples, the client identifier component 975 may be configured as or otherwise support a means for receiving, after completion of the onboarding procedure, a client identifier, wherein initiating the payload for the signature at the blockchain address application and the registration via the smart contract is based at least in part on the client identifier.

FIG. 10 shows a diagram of a system 1000 including a system 1005 that supports recurring on-chain transfers in accordance with aspects of the present disclosure. The system 1005 may be an example of or include components of a system 805 as described herein. The system 1005 may include components for bi-directional voice and data communications including components for transmitting and receiving communications, such as a recurring on-chain transfer manager 1020, an input information 1010, an output information 1015, a network interface 1025, at least one memory 1030, at least one processor 1035, and a storage 1040. Each of these components may communicate, directly or indirectly, with one another (e.g., via one or more buses, communications links, communications interfaces, or any combination thereof).

The network interface 1025 may enable the system 1005 to exchange information (e.g., input information 1010, output information 1015, or both) with other systems or devices (not shown). For example, the network interface 1025 may enable the system 1005 to connect to a network (e.g., a network 135 as described herein). The network interface 1025 may include one or more wireless network interfaces, one or more wired network interfaces, or any combination thereof.

Memory 1030 may include RAM, ROM, or both. The memory 1030 may store computer-readable, computer-executable software including instructions that, when executed, cause at least one processor 1035 to perform various functions described herein, such as functions supporting recurring on-chain transfers. In some cases, the memory 1030 may contain, among other things, a basic input/output system (BIOS), which may control basic hardware or software operation such as the interaction with peripheral components or devices. In some cases, the memory 1030 may be an example of aspects of one or more components of a custodial token platform 110 as described with reference to FIG. 1. The memory 1030 may be an example of a single memory or multiple memories. For example, the system 1005 may include one or more memories 1030.

The processor 1035 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 1035 may be configured to execute computer-readable instructions stored in at least one memory 1030 to perform various functions (e.g., functions or tasks supporting recurring on-chain transfers). Though a single processor 1035 is depicted in the example of FIG. 10, it is to be understood that the system 1005 may include any quantity of one or more of processors 1035 and that a group of processors 1035 may collectively perform one or more functions ascribed herein to a processor, such as the processor 1035. The processor 1035 may be an example of a single processor or multiple processors. For example, the system 1005 may include one or more processors 1035.

Storage 1040 may be configured to store data that is generated, processed, stored, or otherwise used by the system 1005. In some cases, the storage 1040 may include one or more HDDs, one or more SDDs, or both. In some examples, the storage 1040 may be an example of a single database, a distributed database, multiple distributed databases, a data store, a data lake, or an emergency backup database. In some examples, the storage 1040 may be an example of one or more components described with reference to FIG. 1.

The recurring on-chain transfer manager 1020 may support facilitating recurring on-chain transactions in accordance with examples as disclosed herein. For example, the recurring on-chain transfer manager 1020 may be configured as or otherwise support a means for receiving one or more user inputs to initiate authorization of a plurality of instances of a transfer of a first amount of a first crypto token from a first blockchain address associated with a blockchain application to a second blockchain address. The recurring on-chain transfer manager 1020 may be configured as or otherwise support a means for transmitting, to a blockchain address application after receiving the one or more user inputs, a payload for signature at the blockchain address application and for registration, via a smart contract, of the authorization of the plurality of instances of the transfer. The recurring on-chain transfer manager 1020 may be configured as or otherwise support a means for broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration.

By including or configuring the recurring on-chain transfer manager 1020 in accordance with examples as described herein, the system 1005 may support techniques for reduced resource overhead related to enabling and supporting recurring transfers on a blockchain network.

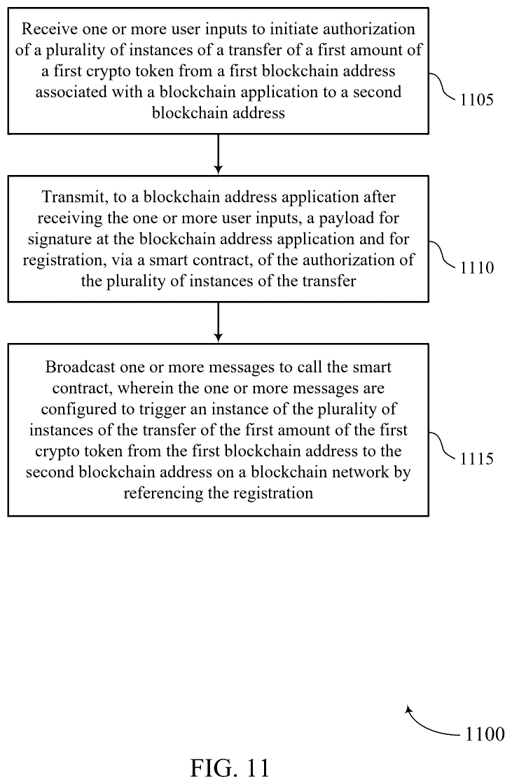

FIG. 11 shows a flowchart illustrating a method 1100 that supports recurring on-chain transfers in accordance with aspects of the present disclosure. The operations of the method 1100 may be implemented by a client or its components as described herein. For example, the operations of the method 1100 may be performed by a client as described with reference to FIGS. 1 through 10. In some examples, a client may execute a set of instructions to control the functional elements of the client to perform the described functions.

Additionally, or alternatively, the client may perform aspects of the described functions using special-purpose hardware.

At 1105, the method may include receiving one or more user inputs to initiate authorization of a plurality of instances of a transfer of a first amount of a first crypto token from a first blockchain address associated with a blockchain application to a second blockchain address. The operations of 1105 may be performed in accordance with examples as disclosed herein. In some examples, aspects of the operations of 1105 may be performed by a user input component 925 as described with reference to FIG. 9.

At 1110, the method may include transmitting, to a blockchain address application after receiving the one or more user inputs, a payload for signature at the blockchain address application and for registration, via a smart contract, of the authorization of the plurality of instances of the transfer. The operations of 1110 may be performed in accordance with examples as disclosed herein. In some examples, aspects of the operations of 1110 may be performed by a signature and authorization request component 930 as described with reference to FIG. 9.

At 1115, the method may include broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration. The operations of 1115 may be performed in accordance with examples as disclosed herein. In some examples, aspects of the operations of 1115 may be performed by a transfer initiation component 935 as described with reference to FIG. 9.

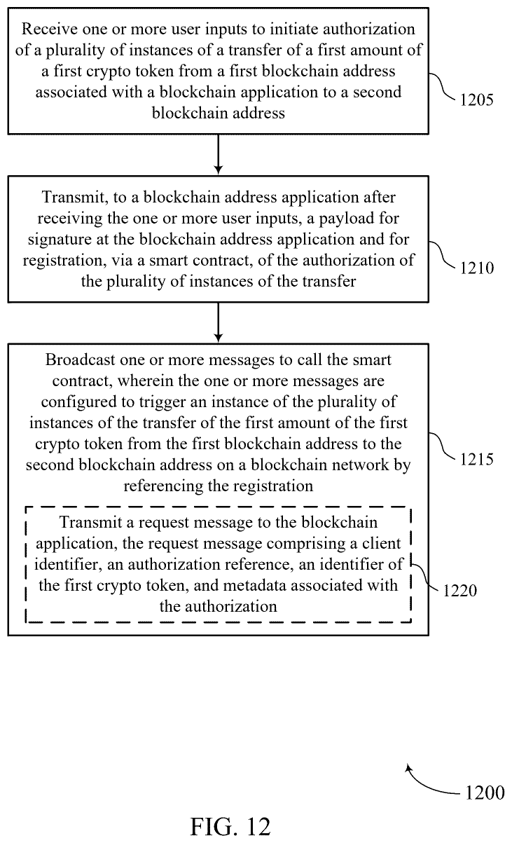

FIG. 12 shows a flowchart illustrating a method 1200 that supports recurring on-chain transfers in accordance with aspects of the present disclosure. The operations of the method 1200 may be implemented by a client or its components as described herein. For example, the operations of the method 1200 may be performed by a client as described with reference to FIGS. 1 through 10. In some examples, a client may execute a set of instructions to control the functional elements of the client to perform the described functions. Additionally, or alternatively, the client may perform aspects of the described functions using special-purpose hardware.

At 1205, the method may include receiving one or more user inputs to initiate authorization of a plurality of instances of a transfer of a first amount of a first crypto token from a first blockchain address associated with a blockchain application to a second blockchain address. The operations of 1205 may be performed in accordance with examples as disclosed herein. In some examples, aspects of the operations of 1205 may be performed by a user input component 925 as described with reference to FIG. 9.

At 1210, the method may include transmitting, to a blockchain address application after receiving the one or more user inputs, a payload for signature at the blockchain address application and for registration, via a smart contract, of the authorization of the plurality of instances of the transfer. The operations of 1210 may be performed in accordance with examples as disclosed herein. In some examples, aspects of the operations of 1210 may be performed by a signature and authorization request component 930 as described with reference to FIG. 9.

At 1215, the method may include broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration. The operations of 1215 may be performed in accordance with examples as disclosed herein. In some examples, aspects of the operations of 1215 may be performed by a transfer initiation component 935 as described with reference to FIG. 9.

At 1220, the method may include transmitting a request message to the blockchain application, the request message comprising a client identifier, an authorization reference, an identifier of the first crypto token, and metadata associated with the authorization. The operations of 1220 may be performed in accordance with examples as disclosed herein. In some examples, aspects of the operations of 1220 may be performed by a signature and authorization request component 930 as described with reference to FIG. 9.

A method for facilitating recurring on-chain transactions by an apparatus is described. The method may include receiving one or more user inputs to initiate authorization of a plurality of instances of a transfer of a first amount of a first crypto token from a first blockchain address associated with a blockchain application to a second blockchain address, transmitting, to a blockchain address application after receiving the one or more user inputs, a payload for signature at the blockchain address application and for registration, via a smart contract, of the authorization of the plurality of instances of the transfer, and broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration.

An apparatus for facilitating recurring on-chain transactions is described. The apparatus may include one or more memories storing processor executable code, and one or more processors coupled with the one or more memories. The one or more processors may individually or collectively be operable to execute the code to cause the apparatus to receive one or more user inputs to initiate authorization of a plurality of instances of a transfer of a first amount of a first crypto token from a first blockchain address associated with a blockchain application to a second blockchain address, transmit, to a blockchain address application after receiving the one or more user inputs, a payload for signature at the blockchain address application and for registration, via a smart contract, of the authorization of the plurality of instances of the transfer, and broadcast one or more messages to call the smart contract, wherein the one or more messages are configured to trigger an instance of the plurality of instances of the transfer of the first amount of the first crypto token from the first blockchain address to the second blockchain address on a blockchain network by referencing the registration.

Another apparatus for facilitating recurring on-chain transactions is described. The apparatus may include means for receiving one or more user inputs to initiate authorization of a plurality of instances of a transfer of a first amount of a first crypto token from a first blockchain address associated with a blockchain application to a second blockchain address, means for transmitting, to a blockchain address application after receiving the one or more user inputs, a payload for signature at the blockchain address application and for registration, via a smart contract, of the authorization of the plurality of instances of the transfer, and means for broadcasting one or more messages to call the smart contract, wherein the one or more messages are configured to trigger an instance of the plurality of instances of the transfer of the first amount of the first crypto token from the first blockchain address to the second blockchain address on a blockchain network by referencing the registration.

A non-transitory computer-readable medium storing code for facilitating recurring on-chain transactions is described. The code may include instructions executable by one or more processors to receive one or more user inputs to initiate authorization of a plurality of instances of a transfer of a first amount of a first crypto token from a first blockchain address associated with a blockchain application to a second blockchain address, transmit, to a blockchain address application after receiving the one or more user inputs, a payload for signature at the blockchain address application and for registration, via a smart contract, of the authorization of the plurality of instances of the transfer, and broadcast one or more messages to call the smart contract, wherein the one or more messages are configured to trigger an instance of the plurality of instances of the transfer of the first amount of the first crypto token from the first blockchain address to the second blockchain address on a blockchain network by referencing the registration.

In some examples of the method, apparatus, and non-transitory computer-readable medium described herein, transmitting the payload for the signature at the blockchain address application and the registration via the smart contract may include operations, features, means, or instructions for transmitting a request message to the blockchain application, the request message comprising a client identifier, an authorization reference, an identifier of the first crypto token, and metadata associated with the authorization.

In some examples of the method, apparatus, and non-transitory computer-readable medium described herein, broadcasting the one or more messages may include operations, features, means, or instructions for broadcasting a request message, the request message comprising an identifier of the registration, a transfer reference, the first amount of the first crypto token, and metadata associated with the transfer.

Some examples of the method, apparatus, and non-transitory computer-readable medium described herein may further include operations, features, means, or instructions for receiving, after initiating the registration via the smart contract, a message indicating that the registration may be complete in accordance with an approval event on the blockchain network and storing the message indicating that the registration may be complete, wherein broadcasting the one or more messages may be based at least in part on storing the message indicating that the registration may be complete.

Some examples of the method, apparatus, and non-transitory computer-readable medium described herein may further include operations, features, means, or instructions for receiving a message indicating that the authorization of one or more instances of the plurality of instances may be revoked and refraining from initiating, at a second instance of the plurality of instances, the transfer after receiving the message indicating that the authorization of the one or more instances of the plurality of instances may be revoked.

Some examples of the method, apparatus, and non-transitory computer-readable medium described herein may further include operations, features, means, or instructions for identifying a cancellation condition associated with the authorization, the cancellation condition indicated by the one or more user inputs and transmitting a message to cancel at least one instance of the plurality of instances via the smart contract.

In some examples of the method, apparatus, and non-transitory computer-readable medium described herein, the cancellation condition comprises a transfer timeout.

Some examples of the method, apparatus, and non-transitory computer-readable medium described herein may further include operations, features, means, or instructions for receiving, via the smart contract, a second amount of the first crypto token, the second amount comprising the first amount minus a third amount of fees associated with the blockchain application.

Some examples of the method, apparatus, and non-transitory computer-readable medium described herein may further include operations, features, means, or instructions for performing, via the blockchain application, an onboarding procedure and receiving, after completion of the onboarding procedure, a client identifier, wherein initiating the payload for the signature at the blockchain address application and the registration via the smart contract may be based at least in part on the client identifier.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for facilitating recurring on-chain transactions, comprising:
receiving one or more user inputs to initiate authorization of a plurality of instances of a transfer of a first amount of a first crypto token from a first blockchain address associated with a blockchain application to a second blockchain address;
transmitting, to a blockchain address application after receiving the one or more user inputs, a payload that initiates an approval event on a blockchain network, and initiates registration, via a smart contract, of the authorization of the plurality of instances of the transfer;
receiving, based at least in part on transmitting the payload, a message indicating that the registration is complete in accordance with the approval event on the blockchain network, the approval event associated with one or more signatures for the payload;
storing, based at least in part on receiving the message, the message indicating that the registration is complete; and
broadcasting, based at least in part on storing the message indicating that the registration is complete, one or more messages to call the smart contract, wherein the one or more messages trigger an instance of the plurality of instances of the transfer of the first amount of the first crypto token from the first blockchain address to the second blockchain address on the blockchain network by referencing the registration.

2. The method of claim 1, wherein transmitting the payload comprises:
transmitting a request message to the blockchain application, the request message comprising a client identifier, an authorization reference, an identifier of the first crypto token, and metadata associated with the authorization.

3. The method of claim 1, wherein broadcasting the one or more messages comprises:
broadcasting a request message, the request message comprising an identifier of the registration, a transfer reference, the first amount of the first crypto token, and metadata associated with the transfer.

4. (canceled)

5. The method of claim 1, further comprising:
receiving a message indicating that the authorization of one or more instances of the plurality of instances is revoked; and
refraining from initiating, at a second instance of the plurality of instances, the transfer after receiving the message indicating that the authorization of the one or more instances of the plurality of instances is revoked.

6. The method of claim 1, further comprising:
identifying a cancellation condition associated with the authorization, the cancellation condition indicated by the one or more user inputs; and
transmitting a message to cancel at least one instance of the plurality of instances via the smart contract.

7. The method of claim 6, wherein the cancellation condition comprises a transfer timeout.

8. The method of claim 1, further comprising:
receiving, via the smart contract, a second amount of the first crypto token, the second amount comprising the first amount minus a third amount of fees associated with the blockchain application.

9. The method of claim 1, further comprising:
performing, via the blockchain application, an onboarding procedure; and
receiving, after completion of the onboarding procedure, a client identifier, wherein initiating the approval event and the registration via the smart contract is based at least in part on the client identifier.

10. An apparatus for facilitating recurring on-chain transactions, comprising:
one or more memories storing processor-executable code; and
one or more processors coupled with the one or more memories and individually or collectively operable to execute the code to cause the apparatus to:
receive one or more user inputs to initiate authorization of a plurality of instances of a transfer of a first amount of a first crypto token from a first blockchain address associated with a blockchain application to a second blockchain address;
transmit, to a blockchain address application after receiving the one or more user inputs, a payload that initiates an approval event on a blockchain network and initiates registration, via a smart contract, of the authorization of the plurality of instances of the transfer;
receive, based at least in part on transmitting the payload, a first message indicating that the registration is complete in accordance with the approval event on the blockchain network, the approval event associated with one or more signatures for the payload;
store, based at least in part on receiving the first message, the first message indicating that the registration is complete; and
broadcast, based at least in part on the first message indicating that the registration is complete, one or more messages to call the smart contract, wherein the one or more messages trigger an instance of the plurality of instances of the transfer of the first amount of the first crypto token from the first blockchain address to the second blockchain address on the blockchain network by referencing the registration.

11. The apparatus of claim 10, wherein, to transmit the payload, the one or more processors are individually or collectively operable to execute the code to cause the apparatus to:
transmit a request message to the blockchain application, the request message comprising a client identifier, an authorization reference, an identifier of the first crypto token, and metadata associated with the authorization.

12. The apparatus of claim 10, wherein, to broadcast the one or more messages, the one or more processors are individually or collectively operable to execute the code to cause the apparatus to:
broadcast a request message, the request message comprising an identifier of the registration, a transfer reference, the first amount of the first crypto token, and metadata associated with the transfer.

13. (canceled)

14. The apparatus of claim 10, wherein the one or more processors are individually or collectively further operable to execute the code to cause the apparatus to:
receive a message indicating that the authorization of one or more instances of the plurality of instances is revoked; and
refrain from initiating, at a second instance of the plurality of instances, the transfer after receiving the message indicating that the authorization of the one or more instances of the plurality of instances is revoked.

15. The apparatus of claim 10, wherein the one or more processors are individually or collectively further operable to execute the code to cause the apparatus to:
identify a cancellation condition associated with the authorization, the cancellation condition indicated by the one or more user inputs; and
transmit a message to cancel at least one instance of the plurality of instances via the smart contract.

16. The apparatus of claim 15, wherein the cancellation condition comprises a transfer timeout.

17. The apparatus of claim 10, wherein the one or more processors are individually or collectively further operable to execute the code to cause the apparatus to:
receive, via the smart contract, a second amount of the first crypto token, the second amount comprising the first amount minus a third amount of fees associated with the blockchain application.

18. The apparatus of claim 10, wherein the one or more processors are individually or collectively further operable to execute the code to cause the apparatus to:
perform, via the blockchain application, an onboarding procedure; and
receive, after completion of the onboarding procedure, a client identifier, wherein initiating the approval event the and the registration via the smart contract is based at least in part on the client identifier.

19. A non-transitory computer-readable medium storing code for facilitating recurring on-chain transactions, the code comprising instructions executable by one or more processors to:
receive one or more user inputs to initiate authorization of a plurality of instances of a transfer of a first amount of a first crypto token from a first blockchain address associated with a blockchain application to a second blockchain address;
transmit, to a blockchain address application after receiving the one or more user inputs, a payload that initiates an approval event on a blockchain network and [[for]] initiates registration, via a smart contract, of the authorization of the plurality of instances of the transfer;
receive, based at least in part on transmitting the payload, a message indicating that the registration is complete in accordance with the approval event on the blockchain network, the approval event associated with one or more signatures for the payload;
store, based at least in part on receiving the message, the message indicating that the registration is complete; and
broadcast, based at least in part on storing the message indicating that the registration is complete, a request message to call the smart contract, wherein the request message comprises metadata associated with the authorization, wherein the metadata trigger an instance of the plurality of instances of the transfer of the first amount of the first crypto token from the first blockchain address to the second blockchain address on the blockchain network by referencing the registration.

20. The non-transitory computer-readable medium of claim 19, wherein the instructions to transmit the payload are executable by the one or more processors to:
transmit a second request message to the blockchain application, the request message comprising a client identifier, an authorization reference, an identifier of the first crypto token, and the metadata associated with the authorization.
